(19) United States
(12) Patent Application Publication
(10) Pub. No.: US 2025/0335158 A1
(43) Pub. Date: Oct. 30, 2025

(54) AUTOMATIC EVALUATION OF ARTIFICIAL INTELLIGENCE-GENERATED CODE SUGGESTIONS

(71) Applicant: SAP SE, Walldorf (DE)

(72) Inventors: Marco Rosa, Biot (FR); Merve Sahin, Antibes (FR)

(21) Appl. No.: 18/644,500

(22) Filed: Apr. 24, 2024

(51) Int. Cl. G06F 8/33

(52) U.S. Cl. CPC G06F 8/33

(57) ABSTRACT

In an example embodiment, a framework is provided to enable more robust and reliable code suggestions for developers, to better encourage them in using AI tools. This framework may be integrated into an AI tool as an additional evaluation layer (before the code suggestion is made to the developer), thus providing them with more reliable suggestions.

### TECHNICAL FIELD

This document generally relates to computer software application development. More specifically, this document relates to the automatic identification of logging inconsistencies in source code.

### BACKGROUND

Computer software may be written using an integrated development environment (IDE), which is a software application that provides developers with a comprehensive set of tools for writing, testing, and debugging code. An IDE typically includes a code editor, a compiler or interpreter, a debugger, and other tools that help developers automate common tasks and streamline their workflow.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system in accordance with an example embodiment.

FIG. 2 is a flow diagram illustrating a method in accordance with an example embodiment.

FIG. 3 is a block diagram illustrating an architecture of software, which can be installed on any one or more of the devices described above.

FIG. 4 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

The recent advancements in Artificial Intelligence (AI) and Natural Language Processing (NLP) gave rise to the development of different code generation tools using Language Models (LLMs). Such tools come in different variations: while some of them can be integrated into the development environment to make real-time code suggestions (e.g., the Copilot IDE plugin by GitHub, Inc. of San Francisco, CA), others provide a chat interface (e.g., ChatGPT by OpenAI, Inc. of San Francisco, CA) that the developers can interact with. These tools have the potential to increase the productivity of developers by accelerating the development process and helping the developers with different features of a programming language, even if they have not used the language before. However, such tools also suffer from the limitations of LLMs, such as hallucinations (e.g., suggesting libraries that do not exist), not being up to date (suggesting the use of a vulnerable method, whose vulnerability was not known at training time), and lack of transparency (suggesting code that is not functional or inefficient).

Additionally, recent studies show that the LLM generated code is not always secure (it may be using vulnerable methods and libraries), and the developers might be relying on tests that will be executed in a later stage of the development lifecycle, without thinking about the security implications of the suggested code in real time.

In an example embodiment, a framework is provided to enable more robust and reliable code suggestions for developers, to better encourage them in using AI tools. This framework may be integrated into an AI tool as an additional evaluation layer (before the code suggestion is made to the developer), thus providing them with more reliable suggestions.

More specifically, a process to automate the choice of the best auto-generated code suggestion from an AI model, without human intervention, is provided. In order to enable this, the developer queries an LLM to generate a number of code suggestions for a given functionality that is being worked on. The developer can directly interact with the model via his development environment or use an external service for this purpose. Each of the suggestions generated by the model is automatically analyzed towards its syntactic correctness, its security, and its functionality. Suggestions not validated towards these 3 pillars are automatically discarded without the intervention of the developer. After the validation phase, as there may still be several valid suggestions, their code quality metrics (e.g., execution time, cyclomatic complexity, cohesion, number of lines of code, etc.) may be calculated and only the one with highest score is returned to the developer.

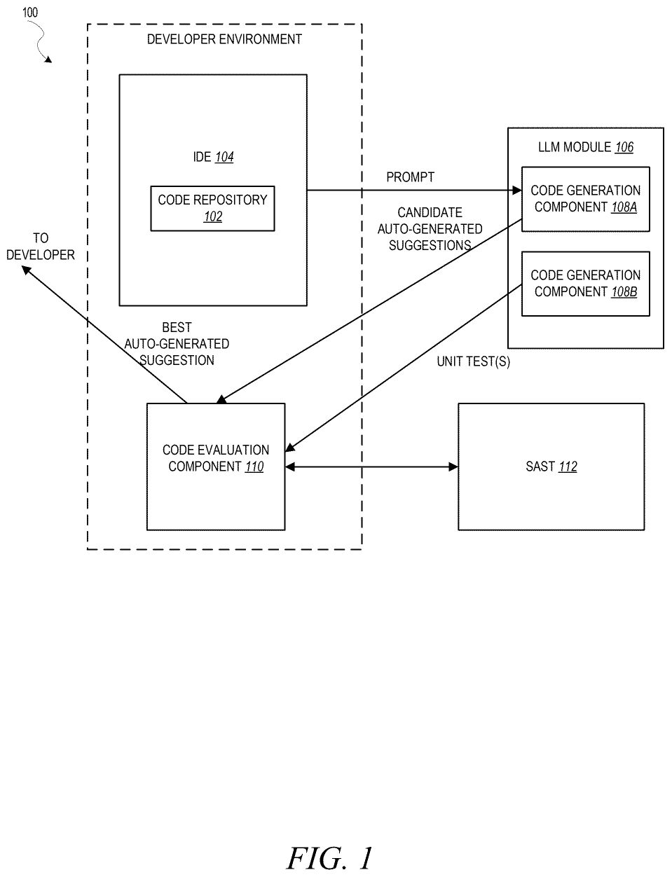

FIG. 1 is a block diagram illustrating a system 100 for automatically evaluated AI-generated code suggestions, in accordance with an example embodiment. An IDE 104 maintains a source code repository 102. The IDE 104 may be public or private, and can be on-premise or in the cloud. Furthermore, in some instances, the IDE 104 may be installed locally on a developer machine, rather than on a platform (or, at least, the source code being examined is on the developer machine, rather than the platform).

An LLM module 106 contains one or more code generation components 108A, 108B that provide code suggestions and unit tests for functionality. The developer may interact with the LLM module 106 via a plugin for the IDE 104, or alternatively may utilize a software agent, such as a chat-based interface, to interact with the LLM module 106. Other mechanisms for interacting with the LLM module are possible as well, including using an Application Program Interface (API) or a Command Line Interface. The LLM module 106 communicates the generated suggestions to a code evaluation component 110 when it is queried. Moreover, the LLM module 106 may be queried again by the code evaluation component 110 to generate test cases. The LLM used by the LLM module 106 to generate the candidate code suggestions and to generate the functional tests could either be the same one used for both those purposes, or separate LLMs (e.g., one LLM for code suggestions and another LLM for functional tests).

A static application security testing (SAST) module 112 may be used to analyze source code to find security vulnerabilities. This module can detect insecure data flows (e.g., a SQL injection vulnerability), functions that are known to be vulnerable (e.g., the “eval( )” method in PHP), or the logging of sensitive information.

The code evaluation component 110 aims to evaluate the AI-generated code suggestions in the background, select the best code suggestion according to a number of criteria, and return the best code suggestion back to the IDE 104 and/or developer. Depending upon implementation, the code evaluation component 110 could be configured as another plugin for the IDE 104 or it may be a service external to the IDE. The code evaluation component 110 can evaluate syntax the code suggestions for syntax, security, functionality, and then compute metrics based on this evaluation. More specifically, the code evaluation component 110 can eliminate the suggestions that do not respect syntactic correctness, security, and functionality criteria, and then choose the best code suggestion according to the software quality metrics. Finally, this selected code suggestion is returned to the developer (or directly embedded in the text editor of the IDE 104).

LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BILS™) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLS™, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

The present solution works with any type of GAI model.

A process for using the solution will now be described. A developer may wish to automatically generate a code function or a block of code. The developer asks a tool, such as an auto-completion tool, to generate the function or block he or she want. Such a tool then generates a prompt to an LLM that includes a description of the desired function. Other information, such as contextual information about the existing source code in which the code function or block will be placed, can also be included in the prompt. The prompt may be constructed partially using a system prompt that is incorporated with the description and contextual information into a prompt that is then sent to the LLM. The system prompt may be a general instruction to the LLM to act in a certain way, such as a description on how to generate computer code generally (not specific to the user's particular request). Moreover, the developer can provide additional context, such as examples for the input parameters of a function to be generated and its expected output, in order to improve the quality of the suggestions generated by the LLM.

The LLM can then provide a number of suggestions for desired code block or function. These may be called “candidate auto-generated suggestions.” As there can be any number of different candidate auto-generated suggestions for the same code block or function, it can be difficult for a developer to analyze, evaluate, and test each of them in real-time. Additionally, it may not be possible for a human to determine whether a particular candidate auto-generated suggestion can cause security or performance issues at a later stage of the development lifecycle process.

Thus, at this point, the framework aims to test each candidate auto-generated suggestion to evaluate its syntactic correctness, security, and functionality. For syntactic correctness, a syntax analyzer or a library to generate an Abstract Syntax Tree (AST) can be used. For security, SAST tools can be used to check for the presence of vulnerable code. For functionality, unit tests may be used. These unit tests may be generated by an LLM (either the same LLM used to provide the code block/function suggestions or a separate LLM). Suggestions that do not comply with these three requirements are discarded.

Turning first to the syntactic correctness, in an example embodiment, AST can be used to represent the code as a tree. The syntax analyzer takes the source code as input and analyzes it according to the rules of the programming language's grammar. This process may include tokenization, where the source code is broken down into a stream of tokens representing keywords, identifiers, operators, and other language constructs. As the syntax analyzer recognizes the syntactic elements of the code, it constructs an AST. The AST represents the hierarchical structure of the code, with each node in the tree representing a different syntactic construct, such as expressions, statements, and declarations.

Once the AST is constructed, the syntax analyzer traverses the tree in a systematic manner, such as by using a depth-first or breadth-first traversal technique. During traversal, the analyzer can perform various types of analyses, such as type checking, scope resolution, and semantic validation. As the syntax analyzer traverses the AST, it performs semantic analysis to ensure that the code adheres to the language's semantic rules. This includes checking for type compatibility, variable declaration and usage, function call correctness, and other semantic constraints.

In some example embodiments, the syntax analyzer may itself be implemented as a machine learning model, trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbors, decision trees, and hidden Markov models.

In an example embodiment, a machine learning algorithm used to train such machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

For the syntax analyzer, training data may include computer code that has been labeled as either being syntactically correct or syntactically incorrect. In some example embodiments, for syntactically incorrect code the specific area of the code that is syntactically incorrect may be labeled, along with, optionally, a reason why that area is syntactically incorrect. From this training data, the machine learning algorithm trains the syntax analyzer machine learning model to learn how to identify syntactically correct code and syntactically incorrect code, allowing the code to be analyzed to be fed into the trained model, at which point it will output an indication of whether or not the syntax of the fed code is valid.

In some example embodiments, the training of the machine learning model may take place as a dedicated training phase. In other example embodiments, the machine learning model may be retrained dynamically at runtime based on, for example, developer feedback.

As to the security analyzer, a SAST analyzer can analyze the source code directly, without the need to execute it. This can be performed at the level of individual source code files or modules. The SAST analyzer scans the source code to identify potential vulnerabilities, such as injection flaws (such as SQL injections, command injection, or LDAP injection), cross-site scripting (instances where user-controlled input is output directly into HTML, JavaScript, or the like without proper encoding), insecure authentication (such as hard-coded credentials, weak password storage, or improper session handling), insecure cryptographic practices (such as weak encryption algorithms or insecure key management), sensitive data exposure (allowing for potential leaks of sensitive data, such as credit card numbers, passwords, or other personal data), and access control issues (such as missing authorization checks or insecure configuration of access controls). The SAST analyzer can also trace the flow of data through the code to identify potential security risks, such as unvalidated inputs being used in sensitive operations or data being transmitted over insecure channels.

In some example embodiments, the security analyzer can, like the syntax analyzer, be implemented as a machine learning model, trained by any algorithm from among many different potential supervised or unsupervised machine learning algorithms, again being trained by iterating among various weights that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

For the security analyzer, training data may include computer code that has been labeled as either being a security risk or not a security risk. In some example embodiments, for code identified as a security risk, the specific area of the code that causing the risk may be labeled, along with, optionally, a reason why that area is causing the risk. From this training data, the machine learning algorithm trains the security analyzer machine learning model to learn how to identify code with potential security issues, allowing the code to be analyzed to be fed into the trained model, at which point it will output an indication of whether or not the code is a security risk.

As to the functionality testing, as mentioned earlier, unit tests may be generated by an LLM and these unit tests may be used to test the code that was also generated by an LLM. Thus, the LLM is used to generate not just the code to be tested but also the tests used to test the code that was generated. As mentioned earlier, however, it is not necessary that the same LLM be used to generate both the code and the unit tests, and in some cases it may be preferable to have separate LLMs devoted to these different tasks, especially if one or both of the LLMs are fine-tuned or if it deemed a vulnerability to have the same LLM generate both the code and the tests used to test the code.

If there are several valid auto-generated suggestions, then software quality metrics may be computed for each of them. Here, a set of scripts can be used that can measure different metrics, such a cyclomatic complexity, lines of code, execution time of unit tests, and cohesion. Cohesion metrics measure how well the methods of a class are related to each other. A cohesive class performs one function while a non-cohesive class performs two or more unrelated functions. A non-cohesive class may need to be restructured into two or more smaller classes. High cohesion is desirable since it promotes encapsulation. As a drawback, a highly cohesive class has high coupling between the methods of the class, which in turn indicates high testing effort for that class. Low cohesion indicates inappropriate design and high complexity. It has also been found to indicate a high likelihood of errors. The code suggestion with the highest overall quality score can be returned to the developer.

LCOM4 is one example of such a cohesion test. It measures the number of “connected components” in a class. A connected component is a set of related methods (and class-level variables). There should be only one such a component in each class. If there are 2 or more components, the class should be split into so many smaller classes.

In some cases, a value that exceeds 1 does not make sense to split the class if implementing a form or web page as it would affect the user interface of your program. The explanation is that they store information in the underlying object that may be not directly using in the class itself.

Methods A and B are related if:
1. They both access the same class-level variable, or
2. A calls B, or B calls A.

After determining the related methods, we draw a graph linking the related methods to each other. LCOM4 equals the number of connected groups of methods.
LCOM4=1 indicates a cohesive class, which is the “good” class.
LCOM4>=2 indicates a problem. The class should be split into so many smaller classes.
LCOM4=0 happens when there are no methods in a class. This is also a “bad” class.

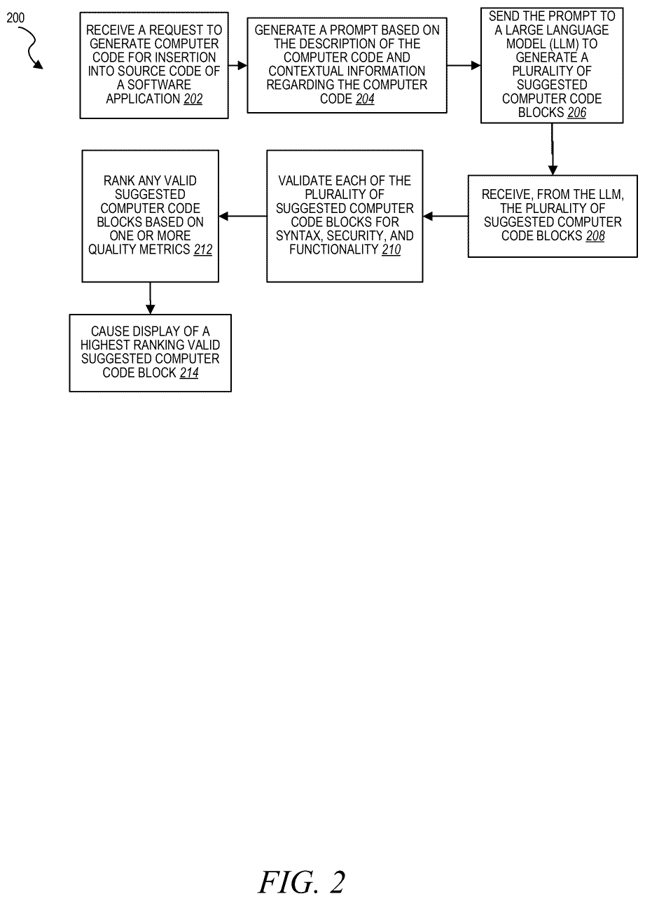

FIG. 2 is a flow diagram illustrating a method 200 in accordance with an example embodiment. At operation 202, a request to generate computer code for insertion into source code of a software application is received. The request may include a description of the computer code. At operation 204, a prompt is generated based on the description of the computer code and contextual information regarding the computer code. At operation 206, the prompt is sent to a Large Language Model (LLM) to generate a plurality of suggested computer code blocks. At operation 208, the plurality of suggested computer code blocks are received from the LLM. At operation 210, each of the plurality of suggested computer code blocks is validated for syntax, security, and functionality. At operation 212, any valid suggested computer code blocks are ranked based on one or more quality metrics. At operation 214, display of a highest ranking valid suggested computer code block is caused to occur.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: receiving a request to generate computer code for insertion into source code of a software application, the request including a description of the computer code; generating a prompt based on the description of the computer code and contextual information regarding the computer code; sending the prompt to a Large Language Model (LLM) to generate a plurality of suggested computer code blocks; receiving, from the LLM, the plurality of suggested computer code blocks; validating each of the plurality of suggested computer code blocks for syntax, security, and functionality; ranking any valid suggested computer code blocks based on one or more quality metrics; and causing display of a highest ranking valid suggested computer code block.

In Example 2, the subject matter of Example 1 includes, wherein the request is received from an Integrated Development Environment (IDE) and the causing the display includes causing the IDE to display the highest ranking valid suggested computer code block.

In Example 3, the subject matter of Example 2 includes, wherein the contextual information includes a location within existing source code at which the requested computer code is to be inserted.

In Example 4, the subject matter of Examples 1-3 includes, wherein the contextual information includes examples of input parameters of a function within the requested computer code.

In Example 5, the subject matter of Examples 1˜4 includes, wherein the contextual information includes examples of output of a function within the requested computer code.

In Example 6, the subject matter of Examples 1-5 includes, wherein the one or more quality metrics include a cohesion metric.

In Example 7, the subject matter of Examples 1-6 includes, wherein security validation is performed by using a static application security testing (SAST) tool.

Example 8 is a method comprising: receiving a request to generate computer code for insertion into source code of a software application, the request including a description of the computer code; generating a prompt based on the description of the computer code and contextual information regarding the computer code; sending the prompt to a Large Language Model (LLM) to generate a plurality of suggested computer code blocks; receiving, from the LLM, the plurality of suggested computer code blocks; validating each of the plurality of suggested computer code blocks for syntax, security, and functionality; ranking any valid suggested computer code blocks based on one or more quality metrics; and causing display of a highest ranking valid suggested computer code block.

In Example 9, the subject matter of Example 8 includes, wherein the request is received from an Integrated Development Environment (IDE) and the causing the display includes causing the IDE to display the highest ranking valid suggested computer code block.

In Example 10, the subject matter of Example 9 includes, wherein the contextual information includes a location within existing source code at which the requested computer code is to be inserted.

In Example 11, the subject matter of Examples 8-10 includes, wherein the contextual information includes examples of input parameters of a function within the requested computer code.

In Example 12, the subject matter of Examples 8-11 includes, wherein the contextual information includes examples of output of a function within the requested computer code.

In Example 13, the subject matter of Examples 8-12 includes, wherein the one or more quality metrics include a cohesion metric.

In Example 14, the subject matter of Examples 8-13 includes, wherein security validation is performed by using a static application security testing (SAST) tool.

Example 15 is a non-transitory machine-readable medium storing instructions which, when executed by one or more processors, cause the one or more processors to perform operations comprising: receiving a request to generate computer code for insertion into source code of a software application, the request including a description of the computer code; generating a prompt based on the description of the computer code and contextual information regarding the computer code; sending the prompt to a Large Language Model (LLM) to generate a plurality of suggested computer code blocks; receiving, from the LLM, the plurality of suggested computer code blocks; validating each of the plurality of suggested computer code blocks for syntax, security, and functionality; ranking any valid suggested computer code blocks based on one or more quality metrics; and causing display of a highest ranking valid suggested computer code block.

In Example 16, the subject matter of Example 15 includes, wherein the request is received from an Integrated Development Environment (IDE) and the causing the display includes causing the IDE to display the highest ranking valid suggested computer code block.

In Example 17, the subject matter of Example 16 includes, wherein the contextual information includes a location within existing source code at which the requested computer code is to be inserted.

In Example 18, the subject matter of Examples 15-17 includes, wherein the contextual information includes examples of input parameters of a function within the requested computer code.

In Example 19, the subject matter of Examples 15-18 includes, wherein the contextual information includes examples of output of a function within the requested computer code.

In Example 20, the subject matter of Examples 15-19 includes, wherein the one or more quality metrics include a cohesion metric.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

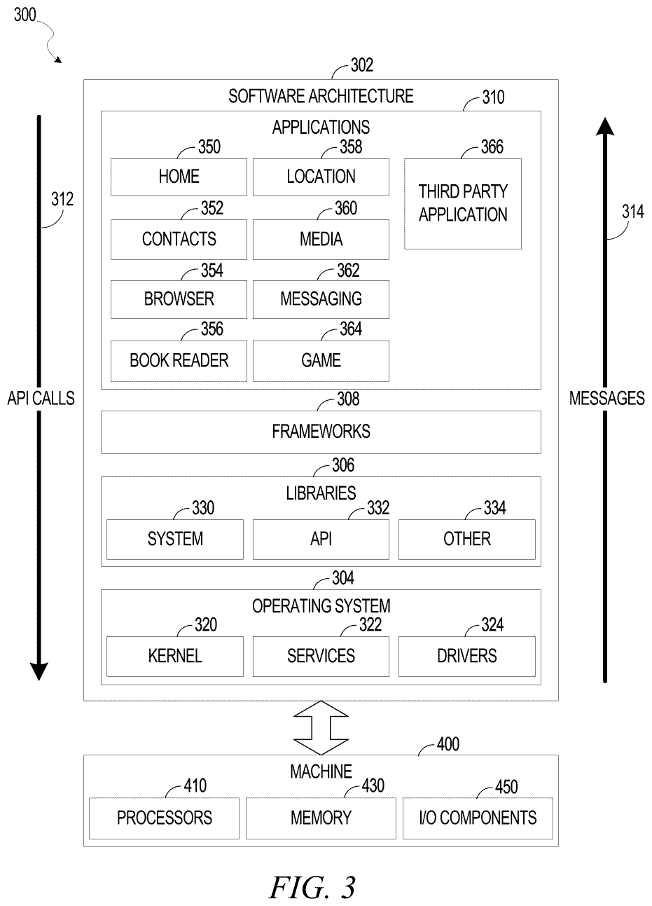

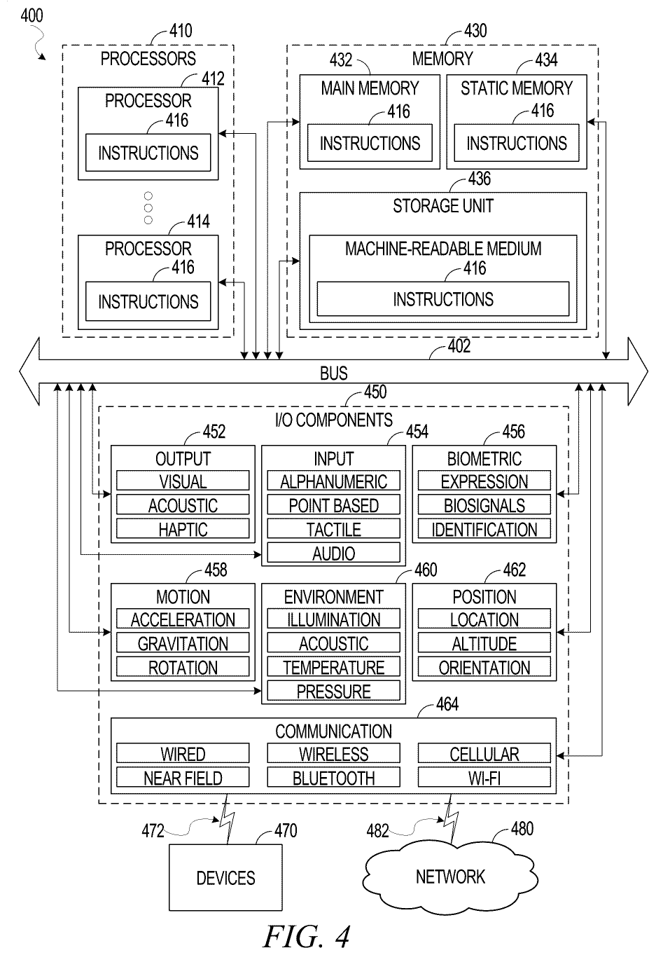

FIG. 3 is a block diagram 300 illustrating a software architecture 302, which can be installed on any one or more of the devices described above. FIG. 3 is merely a non-limiting example of a software architecture, and it will be appreciated that many other architectures can be implemented to facilitate the functionality described herein. In various embodiments, the software architecture 302 is implemented by hardware such as a machine 400 of FIG. 4 that includes processors 410, memory 430, and input/output (I/O) components 450. In this example architecture, the software architecture 302 can be conceptualized as a stack of layers where each layer may provide a particular functionality. For example, the software architecture 302 includes layers such as an operating system 304, libraries 306, frameworks 308, and applications 310. Operationally, the applications 310 invoke API calls 312 through the software stack and receive messages 314 in response to the API calls 312, consistent with some embodiments.

In various implementations, the operating system 304 manages hardware resources and provides common services. The operating system 304 includes, for example, a kernel 320, services 322, and drivers 324. The kernel 320 acts as an abstraction layer between the hardware and the other software layers, consistent with some embodiments. For example, the kernel 320 provides memory management, processor management (e.g., scheduling), component management, networking, and security settings, among other functionalities. The services 322 can provide other common services for the other software layers. The drivers 324 are responsible for controlling or interfacing with the underlying hardware, according to some embodiments. For instance, the drivers 324 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 306 provide a low-level common infrastructure utilized by the applications 310. The libraries 306 can include system libraries 330 (e.g., C standard library) that can provide functions such as memory allocation functions, string manipulation functions, mathematic functions, and the like. In addition, the libraries 306 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic context on a display), database libraries (e.g., SQLite to provide various relational database functions), web libraries (e.g., WebKit to provide web browsing functionality), and the like. The libraries 306 can also include a wide variety of other libraries 334 to provide many other APIs to the applications 310.

The frameworks 308 provide a high-level common infrastructure that can be utilized by the applications 310, according to some embodiments. For example, the frameworks 308 provide various graphical user interface (GUI) functions, high-level resource management, high-level location services, and so forth. The frameworks 308 can provide a broad spectrum of other APIs that can be utilized by the applications 310, some of which may be specific to a particular operating system 304 or platform.

In an example embodiment, the applications 310 include a home application 350, a contacts application 352, a browser application 354, a book reader application 356, a location application 358, a media application 360, a messaging application 362, a game application 364, and a broad assortment of other applications, such as a third-party application 366. According to some embodiments, the applications 310 are programs that execute functions defined in the programs. Various programming languages can be employed to create one or more of the applications 310, structured in a variety of manners, such as object-oriented programming languages (e.g., Objective-C, Java, or C++) or procedural programming languages (e.g., C or assembly language). In a specific example, the third-party application 366 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 366 can invoke the API calls 312 provided by the operating system 304 to facilitate functionality described herein.

FIG. 4 illustrates a diagrammatic representation of a machine 400 in the form of a computer system within which a set of instructions may be executed for causing the machine 400 to perform any one or more of the methodologies discussed herein, according to an example embodiment. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. For example, the instructions 416 may cause the machine 400 to execute the method of FIG. 2. Additionally, or alternatively, the instructions 416 may implement FIGS. 1-3 and so forth. The instructions 416 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory 430, and I/O components 450, which may be configured to communicate with each other such as via a bus 402. In an example embodiment, the processors 410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions 416 contemporaneously. Although FIG. 4 shows multiple processors 410, the machine 400 may include a single processor 412 with a single core, a single processor 412 with multiple cores (e.g., a multi-core processor 412), multiple processors 412, 414 with a single core, multiple processors 412, 414 with multiple cores, or any combination thereof.

The memory 430 may include a main memory 432, a static memory 434, and a storage unit 436, each accessible to the processors 410 such as via the bus 402. The main memory 432, the static memory 434, and the storage unit 436 store the instructions 416 embodying any one or more of the methodologies or functions described herein. The instructions 416 may also reside, completely or partially, within the main memory 432, within the static memory 434, within the storage unit 436, within at least one of the processors 410 (e.g., within the processor's cache memory), or any suitable combination thereof, during execution thereof by the machine 400.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion, and the grouping is in no way limiting. In various example embodiments, the I/O components 450 may include output components 452 and input components 454. The output components 452 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or another suitable device to interface with the network 480. In further examples, the communication components 464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., coupled via a USB).

Moreover, the communication components 464 may detect identifiers or include components operable to detect identifiers. For example, the communication components 464 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

The various memories (e.g., 430, 432, 434, and/or memory of the processor(s) 410) and/or the storage unit 436 may store one or more sets of instructions 416 and data structures (e.g., software) embodying or utilized by any one or more of the methodologies or functions described herein. These instructions (e.g., the instructions 416), when executed by the processor(s) 410, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network, and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., Hypertext Transfer Protocol [HTTP]). Similarly, the instructions 416 may be transmitted or received using a transmission medium via the coupling 472 (e.g., a peer-to-peer coupling) to the devices 470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 416 for execution by the machine 400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
receiving a request to generate computer code for insertion into source code of a software application, the request including a description of the computer code;
generating a prompt based on the description of the computer code and contextual information regarding the computer code;
sending the prompt to a Large Language Model (LLM) to generate a plurality of suggested computer code blocks;
receiving, from the LLM, the plurality of suggested computer code blocks;
validating each of the plurality of suggested computer code blocks for syntax, security, and functionality;
ranking any valid suggested computer code blocks based on one or more quality metrics; and
causing display of a highest ranking valid suggested computer code block.

2. The system of claim 1, wherein the request is received from an Integrated Development Environment (IDE) and the causing the display includes causing the IDE to display the highest ranking valid suggested computer code block.

3. The system of claim 2, wherein the contextual information includes a location within existing source code at which the requested computer code is to be inserted.

4. The system of claim 1, wherein the contextual information includes examples of input parameters of a function within the requested computer code.

5. The system of claim 1, wherein the contextual information includes examples of output of a function within the requested computer code.

6. The system of claim 1, wherein the one or more quality metrics include a cohesion metric.

7. The system of claim 1, wherein security validation is performed by using a static application security testing (SAST) tool.

8. A method comprising:
receiving a request to generate computer code for insertion into source code of a software application, the request including a description of the computer code;
generating a prompt based on the description of the computer code and contextual information regarding the computer code;
sending the prompt to a Large Language Model (LLM) to generate a plurality of suggested computer code blocks;
receiving, from the LLM, the plurality of suggested computer code blocks;
validating each of the plurality of suggested computer code blocks for syntax, security, and functionality;
ranking any valid suggested computer code blocks based on one or more quality metrics; and
causing display of a highest ranking valid suggested computer code block.

9. The method of claim 8, wherein the request is received from an Integrated Development Environment (IDE) and the causing the display includes causing the IDE to display the highest ranking valid suggested computer code block.

10. The method of claim 9, wherein the contextual information includes a location within existing source code at which the requested computer code is to be inserted.

11. The method of claim 8, wherein the contextual information includes examples of input parameters of a function within the requested computer code.

12. The method of claim 8, wherein the contextual information includes examples of output of a function within the requested computer code.

13. The method of claim 8, wherein the one or more quality metrics include a cohesion metric.

14. The method of claim 8, wherein security validation is performed by using a static application security testing (SAST) tool.

15. A non-transitory machine-readable medium storing instructions which, when executed by one or more processors, cause the one or more processors to perform operations comprising:
receiving a request to generate computer code for insertion into source code of a software application, the request including a description of the computer code;
generating a prompt based on the description of the computer code and contextual information regarding the computer code;
sending the prompt to a Large Language Model (LLM) to generate a plurality of suggested computer code blocks;
receiving, from the LLM, the plurality of suggested computer code blocks;
validating each of the plurality of suggested computer code blocks for syntax, security, and functionality;
ranking any valid suggested computer code blocks based on one or more quality metrics; and
causing display of a highest ranking valid suggested computer code block.

16. The non-transitory machine-readable medium of claim 15, wherein the request is received from an Integrated Development Environment (IDE) and the causing the display includes causing the IDE to display the highest ranking valid suggested computer code block.

17. The non-transitory machine-readable medium of claim 16, wherein the contextual information includes a location within existing source code at which the requested computer code is to be inserted.

18. The non-transitory machine-readable medium of claim 15, wherein the contextual information includes examples of input parameters of a function within the requested computer code.

19. The non-transitory machine-readable medium of claim 15, wherein the contextual information includes examples of output of a function within the requested computer code.

20. The non-transitory machine-readable medium of claim 15, wherein the one or more quality metrics include a cohesion metric.
